(19) United States
(12) Patent Application Publication
(10) Pub. No.: US 2026/0177030 A1
(43) Pub. Date: Jun. 25, 2026

(54) METHOD, SYSTEM, AND APPARATUS FOR TEMPORARILY REPLACING FUNCTIONALITY OF FAULTY WIND LIDAR

(71) Applicants: CHINA THREE GORGES FUJIAN ENERGY INVESTMENT CO., LTD., Fuzhou (CN); FUZHOU HAIXIA ELECTRICITY GENERATION CO., LTD., Fuzhou (CN)

(72) Inventors: Zihuang Lin, Fuzhou (CN); Jianbo Wang, Fuzhou (CN); Fujian Li, Fuzhou (CN); Xingzheng Zhou, Fuzhou (CN); Yibo Guo, Fuzhou (CN); Xinrong Wang, Fuzhou (CN); Zhongde Wen, Fuzhou (CN); Weihuan Zhuang, Fuzhou (CN)

(21) Appl. No.: 19/540,619

(22) Filed: Feb. 14, 2026

Related U.S. Application Data
(63) Continuation-in-part of application No. PCT/CN2024/114053, filed on Aug. 22, 2024.

(30) Foreign Application Priority Data
Aug. 22, 2023 (CN) 202311058750.X

(51) Int. Cl. F03D 7/04

(52) U.S. Cl. CPC F03D 7/046; F03D 7/048

(57) ABSTRACT

Provided are a method, system, and apparatus for temporarily replacing functionality of a faulty wind lidar. The system includes: a detection module configured to analyze output data of a wind lidar, determine whether the lidar is faulty, and if yes, output a logical value of 0, or if not, output a logical value of 1; a data switching module configured to switch a data source of the system from a simulation system data source to a wind lidar data source when the logical value changes from 0 to 1, from the lidar data source to the simulation system data source when the logical value changes from 1 to 0, and maintain an original status when the logical value does not change; and a data fusion and splitting module configured to fuse and split historical wind farm meteorological data and historical meteorological forecast data into a latent noise variable.

### CROSS REFERENCE TO RELATED APPLICATION

The present application is a continuation-in-part of International Patent Application No. PCT/CN2024/114053, filed on Aug. 22, 2024, which claims priority to Chinese Patent Application No. 202311058750X, filed with the China National Intellectual Property Administration (CNIPA) on Aug. 22, 2023 and entitled “METHOD, SYSTEM, AND APPARATUS FOR TEMPORARILY REPLACING FAULTY WIND LIDAR”. Both of the foregoing applications are incorporated herein by reference in their entireties.

### TECHNICAL FIELD

The present application relates to the field of wind lidars, and in particular, to a method, system, and apparatus for temporarily replacing functionality of a faulty wind lidar.

### BACKGROUND

Due to dynamic characteristics of wind resources, in order to accurately assess renewable energy output, a wind lidar is usually installed in an offshore wind farm for wind resource measurement. The wind lidar is equivalent to a small meteorological station, which can monitor a plurality of pieces of meteorological information data in real time, for example, five main types of information: wind speed, wind direction, temperature, air pressure, and humidity. However, as siting of the offshore wind farm gradually moves from nearshore to deep-sea locations, if the wind lidar is faulty, personnel cannot arrive in time for repair. Consequently, all meteorological measurement data during a fault period is lost, resulting in direct impact on assessment of wind farm output.

### SUMMARY

An objective of the present application is to provide a method, system, and apparatus for temporarily replacing functionality of a faulty wind lidar, to resolve a problem of temporarily replacing functionality of a faulty wind lidar, which can reduce negative impact of the wind lidar fault on assessment of wind farm output.

The present application provides a method for temporarily replacing functionality of a faulty wind lidar, including:
analyzing, by a detection module, output data of a wind lidar, determining, based on an analysis result, whether the wind lidar is faulty, and in response to that the wind lidar is faulty, outputting a logical value of 0; or in response to that the wind lidar is not faulty, outputting a logical value of 1;
switching, by a data switching module, a data source of a system for temporarily replacing functionality of a faulty wind lidar from a simulation system data source to a wind lidar data source when the logical value changes from 0 to 1, switching the data source of the system for temporarily replacing functionality of a faulty wind lidar from the wind lidar data source to the simulation system data source when the logical value changes from 1 to 0, and maintaining an original status when the logical value does not change; and
fusing and splitting, by a data fusion and splitting module, historical wind farm meteorological data and historical meteorological forecast data into a latent noise variable, and restoring the latent noise variable to future wind farm meteorological data under action of future meteorological forecast data.

Based on the foregoing technical content, when the detection module detects that the wind lidar is faulty, the data switching module switches from the wind lidar data source to the simulation system data source. A core component (namely, the data fusion and splitting module) of the simulation system first fuses and splits the high-resolution historical wind farm meteorological data and the low-resolution historical meteorological forecast data into the latent noise variable, and then restores the latent noise variable to the high-resolution future wind farm meteorological data under the action of the low-resolution future meteorological forecast data. High resolution means that data is obtained on a small scale (in a small geographic range) with high accuracy. Low resolution means that data is obtained on a large scale (in a large geographic range) with low accuracy. Therefore, actual meteorological information output by the wind lidar can be effectively replaced during its fault period, and negative impact of the wind lidar fault on assessment of wind farm output can be reduced. High resolution means that data is obtained on a small scale with high accuracy. Low resolution means that data is obtained on a large scale with low accuracy.

It should be noted that the future wind farm meteorological data includes a wind speed, wind direction, temperature, air pressure, and humidity. The five types of future wind farm meteorological information, namely, the wind speed, wind direction, temperature, air pressure, and humidity, are obtained mainly for the following reasons:

The wind speed directly determines a generated power of a wind turbine (the generated power of the wind turbine is proportional to the cube of the wind speed). Wind speed prediction may be used for predicting the generated power of the wind turbine, wind turbine operation and maintenance plans, and extreme wind warnings. For example, for the wind turbine operation and maintenance plans, the wind turbine needs monthly inspection, quarterly inspection, and annual inspection. During inspection, the wind turbine needs to be shut down. It is not suitable to shut down the wind turbine when the wind is strong. It can only be shut down when the wind is weak.

Wind direction prediction can: 1. Optimize a yaw system: The wind turbine needs to face an incoming wind direction. The yaw system is configured to control an orientation of the wind turbine, usually aligning the wind turbine with a direction of maximum wind force. Therefore, predicting the wind direction helps the yaw system act in advance, to reduce a yaw alignment error and capture maximum wind energy. 2. Optimize a wind farm flow field: For a large wind farm, a wake flow generated by a front-row wind turbine affects a rear-row wind turbine. Therefore, predicting the wind direction helps optimize coordinated control of the entire wind farm, reduce impact of the wake flow, and increase a total power generation of the entire wind farm.

The air pressure and the temperature jointly determine an air density. The generated power of the wind turbine is proportional to the air density. Under high-temperature and low-pressure conditions (such as in summer), the air density is low. Even at the same wind speed, the actual generated power of the wind turbine is lower than that of the wind turbine under cool and high-pressure conditions (such as in winter). Therefore, accurate temperature and air pressure prediction can correct a power prediction model of the wind turbine and improve accuracy.

Humidity prediction has the following benefits: 1. Icing prediction: High humidity combined with low temperature is a necessary condition for blade icing and key input of an icing prediction model. 2. Device protection: High humidity may affect insulation performance of an electrical device. Prediction helps strengthen monitoring. 3. Power fine-tuning: A density of humid air is slightly different from that of dry air. Humidity may be used as a fine-tuning parameter for predicting the generated power of the wind turbine.

In a possible implementation, an implementation process of fusing and then splitting based on the historical wind farm meteorological data and meteorological forecast data through the fusion and splitting module is as follows: A conditional autoregressive flow model is used to fuse the high-resolution historical wind farm meteorological data and the low-resolution historical meteorological forecast data and explore interactions among different dimensions of historical meteorological data in a forward process; and restore the latent noise variable obtained through splitting in the forward process to the high-resolution future wind farm meteorological data under the action of the low-resolution future meteorological forecast data through an invertible structure and maintain the interactions among the different dimensions of historical meteorological data in a backward process.

Further, the conditional autoregressive flow model is used to model a multidimensional data distribution of meteorological information with different resolutions (namely, the historical wind farm meteorological data and the historical meteorological forecast data) such that the interactions among the different dimensions of meteorological data can be explored. In addition, the invertible structure helps maintain the interactions in a fusion and splitting process.

In a possible implementation, the conditional autoregressive flow model includes a compression layer, a periodic fitting layer, an invertible convolutional layer, an affine coupling layer, and a splitting layer that are sequentially connected.

The compression layer is configured to: in the forward process, compress the historical wind farm meteorological data and the historical meteorological forecast data, extract key features of the historical wind farm meteorological data and the historical meteorological forecast data, and input the key features into the periodic fitting layer, where the key features include a wind speed, wind direction, temperature, air pressure, and humidity; and in the backward process, restore a combination of the future meteorological forecast data and the latent noise variable to the future wind farm meteorological data.

The periodic fitting layer is configured to: in the forward process, learn periodic patterns of data obtained by compressing the historical wind farm meteorological data and the historical meteorological forecast data through the compression layer; and in the backward process, ensure that the generated future wind farm meteorological data adheres to the learned periodic patterns.

The invertible convolutional layer is configured to shuffle and reorganize the wind speed, wind direction, temperature, air pressure, and humidity in the historical wind farm meteorological data and the historical meteorological forecast data, and input shuffled and reorganized information into the affine coupling layer.

The affine coupling layer is configured to obtain an interaction between each dimension in the wind speed, wind direction, temperature, air pressure, and humidity and the other dimensions based on an affine function, and learn and maintain the interactions among the different dimensions of meteorological data.

The splitting layer is configured to: in the forward process, convert one piece of data obtained through splitting into the latent noise variable and ensure that another piece of data obtained through the splitting has maximum similarity with the historical meteorological forecast data; and in the backward process, receive the future meteorological forecast data, and combine the future meteorological forecast data with the latent noise variable into hybrid multi-resolution data.

A condition of the conditional autoregressive flow model is to achieve maximal fluidity by performing both forward and backward information propagation based on neighborhood content of the future meteorological forecast data, to effectively guide construction of the future wind farm meteorological data.

In a possible implementation, that the affine coupling layer is configured to obtain the interaction between each dimension in the wind speed, wind direction, temperature, air pressure, and humidity and the other dimensions based on the affine function specifically includes:
in a first phase, fixing input oᵢ,tᵢ,hᵢ,pᵢ and output oᵢ₊₁,tᵢ₊₁,hᵢ₊₁,pᵢ₊₁ of the following four dimensions: wind direction o, temperature t, humidity h, and air pressure p, that is, oᵢ₊₁,tᵢ₊₁,hᵢ₊₁,pᵢ₊₁=oᵢtᵢ,hᵢ,pᵢ; and performing affine transformation on input sᵢ based on the input oᵢ,tᵢ,hᵢ,pᵢ of the four dimensions to obtain output sᵢ₊₁, where s denotes the wind speed dimension, a formula for the affine transformation is sᵢ₊₁=wₛ(oᵢ,tᵢ,hᵢ,pᵢ)*sᵢ+wₑ(oᵢ,tᵢ,hᵢ,pᵢ), and a scaling function wₛ and a translation function wₑ are neural network models to be learned;
in a second phase, fixing input sᵢ,tᵢ,hᵢ,pᵢ and output sᵢ₊₁,tᵢ₊₁,hᵢ₊₁,pᵢ₊₁ of the following four dimensions: wind speed s, temperature t, humidity h, and air pressure p; and performing affine transformation on input oᵢ based on the input sᵢ,tᵢ,hᵢ,pᵢ of the four dimensions to obtain output oᵢ₊₁, where o denotes the wind direction dimension;
in a third phase, fixing input sᵢ,oᵢ,hᵢ,pᵢ and output sᵢ₊₁,oᵢ₊₁,hᵢ₊₁,pᵢ₊₁ of the following four dimensions: wind speed s, wind direction o, humidity h, and air pressure p; and performing affine transformation on input t; based on the input sᵢ,oᵢ,hᵢ,pᵢ of the four dimensions to obtain output tᵢ₊₁, where t denotes the temperature dimension;
in a fourth phase, fixing input sᵢ,oᵢ,tᵢ,pᵢ and output sᵢ₊₁,oᵢ₊₁,tᵢ₊₁,pᵢ₊₁ of the following four dimensions: wind speed s, wind direction o, temperature t, and air pressure p; and performing affine transformation on input hᵢ based on the input sᵢ,oᵢ,tᵢ,pᵢ of the four dimensions to obtain output hᵢ₊₁, where h denotes the humidity dimension; and
in a fifth phase, fixing input sᵢ,oᵢ,tᵢ,hᵢ and output sᵢ₊₁,oᵢ₊₁,tᵢ₊₁,hᵢ₊₁ of the following four dimensions: wind speed s, wind direction o, temperature t, and humidity h; and performing affine transformation on input pᵢ based on the input sᵢ,oᵢ,tᵢ,hᵢ of the four dimensions to obtain output pᵢ₊₁, where p denotes the air pressure dimension.

Mutual conversion of fusion and splitting is achievable because the affine transformation is an invertible process. The interactions among the meteorological data dimensions are discernible through alternate transformation applied across the five phases. Learning the interactions improves accuracy of generating the future wind farm meteorological data in both forward and backward fusion and splitting conversion processes.

Further, the affine transformation in each of the five phases in the affine coupling layer is an invertible process. Through cyclic transformation (that is, several dimensions are fixed to solve a specific dimension in each phase until all dimensions are traversed), the interactions among the different dimensions is obtained. This can yield higher resolution in multidimensional data distribution of the future wind farm meteorological data constructed through the conditional autoregressive flow model.

The present application further provides a system for temporarily replacing functionality of a faulty wind lidar, including:
a detection module configured to analyze output data of a wind lidar, determine, based on an analysis result, whether the wind lidar is faulty, and in response to that the wind lidar is faulty, output a logical value of 0; or in response to that the wind lidar is not faulty, output a logical value of 1;
a data switching module configured to switch a data source of the system for temporarily replacing functionality of a faulty wind lidar from a simulation system data source to a wind lidar data source when the logical value changes from 0 to 1, switch the data source of the system for temporarily replacing functionality of a faulty wind lidar from the wind lidar data source to the simulation system data source when the logical value changes from 1 to 0, and maintain an original status when the logical value does not change; and
a data fusion and splitting module configured to fuse and split historical wind farm meteorological data and historical meteorological forecast data into a latent noise variable, and restore the latent noise variable to future wind farm meteorological data under action of future meteorological forecast data.

In a possible implementation, an implementation process of fusing and then splitting based on the historical wind farm meteorological data and meteorological forecast data through the fusion and splitting module is as follows: A conditional autoregressive flow model is used to fuse the high-resolution historical wind farm meteorological data and the low-resolution historical meteorological forecast data and explore interactions among different dimensions of historical meteorological data in a forward process; and restore the latent noise variable obtained in the forward process to the high-resolution future wind farm meteorological data under the action of the low-resolution future meteorological forecast data through an invertible structure and maintain the interactions among the different dimensions of historical meteorological data in a backward process.

In a possible implementation, the conditional autoregressive flow model includes a compression layer, a periodic fitting layer, an invertible convolutional layer, an affine coupling layer, and a splitting layer that are sequentially connected.

The compression layer is configured to: in the forward process, compress the historical wind farm meteorological data and the historical meteorological forecast data, extract key features of the historical wind farm meteorological data and the historical meteorological forecast data, and input the key features into the periodic fitting layer, where the key features include a wind speed, wind direction, temperature, air pressure, and humidity; and in the backward process, restore a combination of the future meteorological forecast data and the latent noise variable to the future wind farm meteorological data.

The periodic fitting layer is configured to: in the forward process, learn periodic patterns of data obtained by compressing the historical wind farm meteorological data and the historical meteorological forecast data through the compression layer; and in the backward process, ensure that the generated future wind farm meteorological data adheres to the learned periodic patterns.

The invertible convolutional layer is configured to shuffle and reorganize the wind speed, wind direction, temperature, air pressure, and humidity in the historical wind farm meteorological data and the historical meteorological forecast data, and input shuffled and reorganized information into the affine coupling layer.

The affine coupling layer is configured to capture the interdependencies between each dimension and the remaining dimensions through affine transformations, covering wind speed, wind direction, temperature, air pressure, and humidity. It effectively learns and maintains interactions among the meteorological variables to obtain an interaction relationship between each dimension in the wind speed, wind direction, temperature, air pressure, and humidity and the other dimensions based on an affine function, and learn and maintain the interaction relationship between the different dimensions.

The splitting layer is configured to: in the forward process, convert one piece of data obtained through splitting into the latent noise variable and ensure that another piece of data obtained through the splitting has maximum similarity with the historical meteorological forecast data; and in the backward process, receive the future meteorological forecast data, and combine the future meteorological forecast data with the latent noise variable into hybrid multi-resolution data.

A condition of the conditional autoregressive flow model is to achieve maximal fluidity by performing both forward and backward information propagation based on neighborhood content of the future meteorological forecast data, to guide construction of the future wind farm meteorological data.

In a possible implementation, that the affine coupling layer is configured to obtain the interaction between each dimension in the wind speed, wind direction, temperature, air pressure, and humidity and the other dimensions based on the affine function specifically includes:
in a first phase, fixing input oᵢ,tᵢ,hᵢ,pᵢ and output oᵢ₊₁,tᵢ₊₁,hᵢ₊₁,pᵢ₊₁ of the following four dimensions: wind direction o, temperature t, humidity h, and air pressure p, that is, oᵢ₊₁,tᵢ₊₁,hᵢ₊₁,pᵢ₊₁=oᵢ,tᵢ,hᵢ,pᵢ; and performing affine transformation on input sᵢ based on the input oᵢ,tᵢ,hᵢ,pᵢ of the four dimensions to obtain output sᵢ₊₁, where s denotes the wind speed dimension, a formula for the affine transformation is sᵢ₊₁=wₛ (oᵢ,tᵢ,hᵢ,pᵢ)*sᵢ+wₑ(oᵢ,tᵢ,hᵢ,pᵢ), and a scaling function wₛ and a translation function wₑ are neural network models to be learned;
in a second phase, fixing input sᵢ,tᵢ,hᵢ,pᵢ and output sᵢ₊₁,tᵢ₊₁,hᵢ₊₁,pᵢ₊₁ of the following four dimensions: wind speed s, temperature t, humidity h, and air pressure p; and performing affine transformation on input oᵢ based on the input sᵢ,tᵢ,hᵢ,pᵢ of the four dimensions to obtain output oᵢ₊₁, where o denotes the wind direction dimension;
in a third phase, fixing input sᵢ,oᵢ,hᵢ,pᵢ and output sᵢ₊₁,oᵢ₊₁,hᵢ₊₁,pᵢ₊₁ of the following four dimensions: wind speed s, wind direction o, humidity h, and air pressure p; and performing affine transformation on input tᵢ based on the input sᵢ,oᵢ,hᵢ,pᵢ of the four dimensions to obtain output tᵢ₊₁, where t denotes the temperature dimension;
in a fourth phase, fixing input sᵢ,oᵢ,tᵢ,pᵢ and output sᵢ₊₁,oᵢ₊₁,tᵢ₊₁,pᵢ₊₁ of the following four dimensions: wind speed s, wind direction o, temperature t, and air pressure p; and performing affine transformation on input hᵢ based on the input sᵢ,oᵢ,tᵢ,pᵢ of the four dimensions to obtain output hᵢ₊₁, where h denotes the humidity dimension; and
in a fifth phase, fixing input sᵢ,oᵢ,tᵢ,hᵢ and output sᵢ₊₁,oᵢ₊₁,tᵢ₊₁,hᵢ₊₁ of the following four dimensions: wind speed s, wind direction o, temperature t, and humidity h; and performing affine transformation on input pᵢ based on the input sᵢ,oᵢ,tᵢ,hᵢ of the four dimensions to obtain output pᵢ₊₁, where p denotes the air pressure dimension.

Mutual conversion of fusion and splitting is achievable because the affine transformation is an invertible process. The interactions among the meteorological data dimensions are discernible through alternate transformation applied across the five phases. Learning the interactions improves accuracy of generating the future wind farm meteorological data in both forward and backward fusion and splitting conversion processes.

The embodiments of the present application further provide an apparatus for temporarily replacing functionality of a faulty wind lidar, including: a memory, a processor, and a computer program stored in the memory and executable on the processor. The computer program, when executed by the processor, implements the steps of the foregoing method.

The embodiments of the present application further provide a non-transitory computer-readable storage medium. The non-transitory computer-readable storage medium stores a program for implementing information transfer. The program, when executed by a processor, implements the steps of the foregoing method.

The embodiments of the present application further provide a computer program product, including a non-transitory computer-readable storage medium that contains computer-readable program code. The computer-readable program code, when executed by a processor, implements the steps of the foregoing method.

Through the embodiments of the present application, functionality of the faulty wind lidar can be temporarily replaced such that meteorological information is predicted during a fault period of the wind lidar, and negative impact of the wind lidar fault on assessment of wind farm output can be reduced.

The foregoing description is merely a summary of the technical solutions of the present application. To allow the technical means of the present application to be understood more clearly and implemented in accordance with the content of the specification and allow the foregoing and other objectives, features, and advantages of the present application to be more obviously and easily understood, specific implementations of the present application are described below.

### BRIEF DESCRIPTION OF THE DRAWINGS

To describe the technical solutions in the specific implementations of the present application or the prior art more clearly, the accompanying drawings required for describing the specific implementations or the prior art are briefly described below. Apparently, the accompanying drawings in the following description show merely some implementations of the present application, and those of ordinary skill in the art may still derive other drawings from these accompanying drawings without creative efforts.

FIG. 1 is a flowchart of a method for temporarily replacing functionality of a faulty wind lidar according to an embodiment of the present application;

FIG. 2 is a schematic diagram of a system for temporarily replacing functionality of a faulty wind lidar according to an embodiment of the present application;

FIG. 3 is a schematic diagram of an apparatus for temporarily replacing functionality of a faulty wind lidar according to an embodiment of the present application;

FIG. 4 is a structural block diagram of a system for temporarily replacing functionality of a faulty wind lidar according to an embodiment of the present application;

FIG. 5 is a schematic diagram of fusing and splitting historical wind farm meteorological data and historical meteorological forecast data into a latent noise variable through a conditional autoregressive flow model in a forward process according to an embodiment of the present application; and

FIG. 6 is a schematic diagram of restoring a latent noise variable to future wind farm meteorological data under action of future meteorological forecast data through a conditional autoregressive flow model in a backward process according to an embodiment of the present application.

### DETAILED DESCRIPTION

The following clearly and completely describes the technical solutions of the present application with reference to the embodiments. Apparently, the described embodiments are merely some rather than all of the embodiments of the present application. All other embodiments obtained by a person of ordinary skill in the art based on the embodiments of the present application without creative efforts shall fall within the protection scope of the present application.

### Method Embodiment

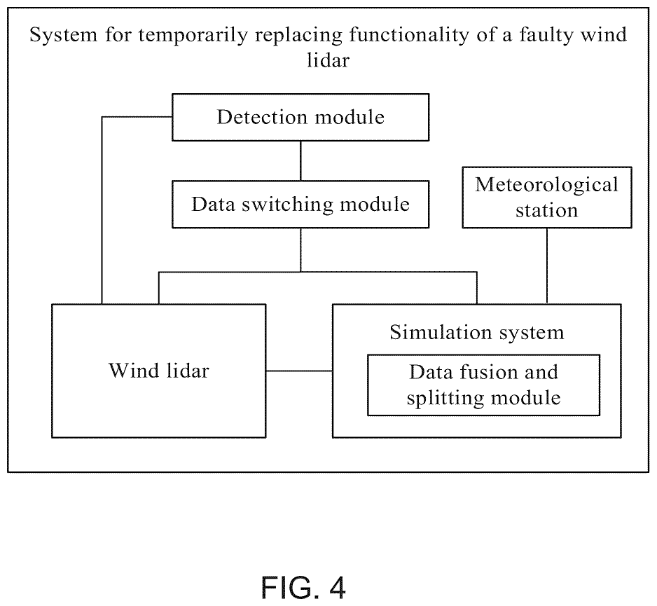

Referring to FIG. 4, the embodiments of the present disclosure provide a system for temporarily replacing functionality of a faulty wind lidar, including a wind farm meteorological data prediction system (namely, a simulation system), a wind lidar, a detection module, and a data switching module. The simulation system is provided with a data fusion and splitting module.

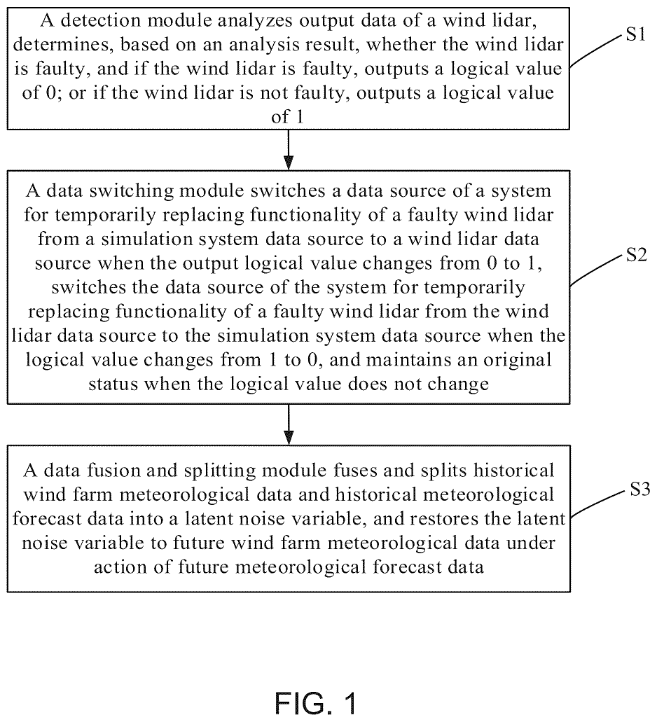

The embodiments of the present application provide a method for temporarily replacing functionality of a faulty wind lidar. FIG. 1 is a flowchart of a method for temporarily replacing functionality of a faulty wind lidar according to an embodiment of the present application. As shown in FIG. 1, the method specifically includes:

The detection module analyzes output data of a wind lidar, determines, based on an analysis result, whether the wind lidar is faulty, and in response to that the wind lidar is faulty, outputs a logical value of 0; or in response to that the wind lidar is not faulty, outputs a logical value of 1.

The data switching module switches a data source of the system for temporarily replacing functionality of a faulty wind lidar from a simulation system data source to a wind lidar data source when the logical value changes from 0 to 1, switches the data source of the system for temporarily replacing functionality of a faulty wind lidar from the wind lidar data source to the simulation system data source when the logical value changes from 1 to 0, and maintains an original status when the logical value does not change.

The data fusion and splitting module first fuses and splits historical wind farm meteorological data and historical meteorological forecast data into a latent noise variable, and then restores the latent noise variable to future wind farm meteorological data under action of future meteorological forecast data.

The data fusion and splitting module in this embodiment first fuses and splits the high-resolution historical wind farm meteorological data and the low-resolution historical meteorological forecast data into the latent noise variable, and then restores the latent noise variable to the high-resolution future wind farm meteorological data under the action of the low-resolution future meteorological forecast data. High resolution means that data is obtained on a small scale (in a small geographic range) with high accuracy. Low resolution means that data is obtained on a large scale (in a large geographic range) with low accuracy.

In the embodiments of the present disclosure, the system for temporarily replacing functionality of a faulty wind lidar is configured to output wind farm meteorological data. The data source of the system for temporarily replacing functionality of a faulty wind lidar is a source of the wind farm meteorological data output by the system for temporarily replacing functionality of a faulty wind lidar. In response to that the wind lidar is not faulty, the data source of the system for temporarily replacing functionality of a faulty wind lidar comes from actual output data of the wind lidar (namely, the wind lidar data source, which is specifically wind farm meteorological data monitored by the wind lidar, including five types of meteorological data: wind speed, wind direction, temperature, air pressure, and humidity). In response to that the wind lidar is faulty, the data source of the system for temporarily replacing functionality of a faulty wind lidar comes from output data of the wind farm meteorological data prediction system (namely, the simulation system data source, which is specifically the future wind farm meteorological data predicted by the data fusion and splitting module, including five types of meteorological data: wind speed, wind direction, temperature, air pressure, and humidity).

In the embodiments of the present disclosure, an implementation process of fusing and then splitting based on the historical wind farm meteorological data and the historical meteorological forecast data through the fusion and splitting module is as follows: A conditional autoregressive flow model is used to fuse the high-resolution historical wind farm meteorological data and the low-resolution historical meteorological forecast data and explore interactions among different dimensions of historical meteorological data in a forward process; and restore the latent noise variable obtained through splitting in the forward process to the high-resolution future wind farm meteorological data under the action of the low-resolution future meteorological forecast data through an invertible structure and maintain the interactions among the different dimensions of historical meteorological data in a backward process. The invertible structure refers to a compression layer, a periodic fitting layer, an invertible convolutional layer, an affine coupling layer, and a splitting layer below.

In the embodiments of the present disclosure, the historical wind farm meteorological data is the following five types of wind farm meteorological information historically monitored by the wind lidar: wind speed, wind direction, temperature, air pressure, and humidity. The historical meteorological forecast data is specifically the following five types of meteorological information in a historical meteorological forecast (for example, a weather forecast from a meteorological station, a meteorological satellite, or the like): wind speed, wind direction, temperature, air pressure, and humidity. Meteorological forecasts are mainly made in a large geographic range, resulting in low prediction accuracy. The data source of the system for temporarily replacing functionality of a faulty wind lidar means that data comes from actual data measured by the wind lidar or data generated by the simulation system.

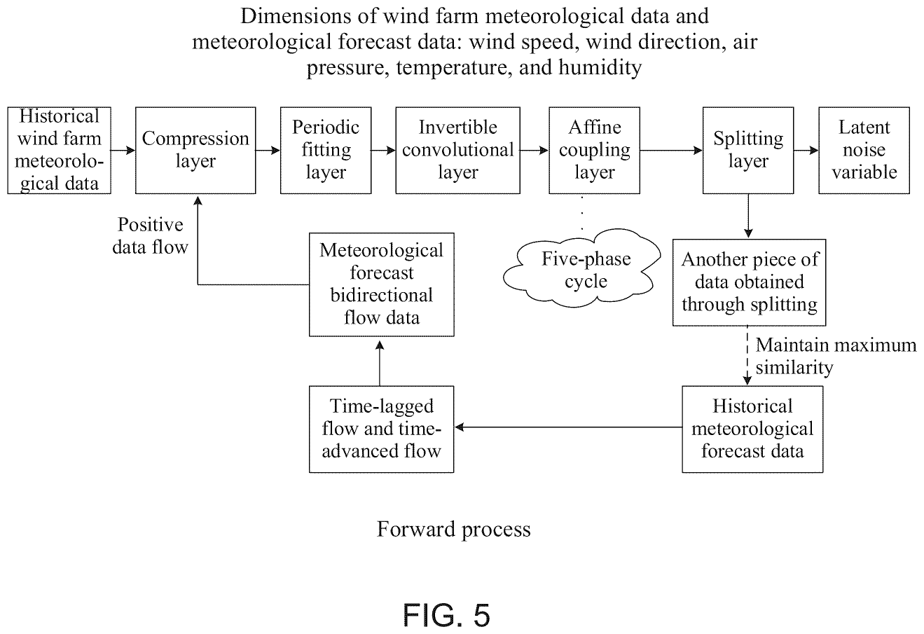

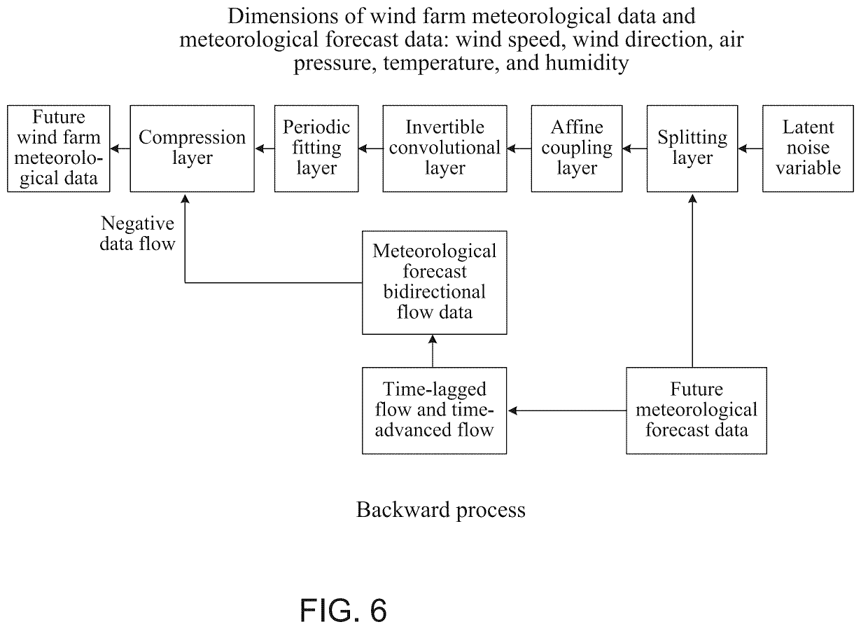

Referring to FIG. 5 and FIG. 6, in the embodiments of the present disclosure, the conditional autoregressive flow model includes the compression layer, periodic fitting layer, invertible convolutional layer, affine coupling layer, and splitting layer that are sequentially connected. The compression layer compresses high-resolution historical meteorological information (namely, the high-resolution historical wind farm meteorological data) and low-resolution historical meteorological information (namely, the low-resolution historical meteorological forecast data), extracts their key features, and inputs the key features into the periodic fitting layer in the forward process; and restores a combination of the future meteorological forecast data and the latent noise variable to the future wind farm meteorological data in the backward process. The periodic fitting layer is configured to: in the forward process, learn periodic patterns of data obtained by compressing the historical wind farm meteorological data and the historical meteorological forecast data through the compression layer; and in the backward process, ensure that the generated future wind farm meteorological data adheres to the learned periodic patterns. The invertible convolutional layer shuffles and reorganizes different dimensions of information (namely, the wind speed, wind direction, temperature, air pressure, and humidity in the historical wind farm meteorological data and the historical meteorological forecast data), and inputs shuffled and reorganized information into the affine coupling layer. The affine coupling layer obtains an interaction between each dimension in the wind speed, wind direction, temperature, air pressure, and humidity and the other dimensions based on an affine function. The affine coupling layer is configured to learn and maintain the interactions among the different dimensions of meteorological data. The splitting layer is configured to: in the forward process, convert one piece of data obtained through splitting into the latent noise variable and ensure that another piece of data obtained through the splitting has maximum similarity with the historical meteorological forecast data; and in the backward process, receive the future meteorological forecast data, and combine the future meteorological forecast data with the latent noise variable into hybrid multi-resolution data. In other words, the splitting layer performs splitting in the forward process to finally obtain two pieces of data: the latent noise variable and data close to the historical meteorological forecast data; and fuses the future meteorological forecast data and the latent noise variable in the backward process. A condition of the conditional autoregressive flow model is to achieve maximal fluidity by performing both forward and backward information propagation based on neighborhood content of the low-resolution meteorological forecast data, to effectively guide construction of the high-resolution future wind farm meteorological data.

That the affine coupling layer obtains the interaction between each dimension in the wind speed, wind direction, temperature, air pressure, and humidity and the other dimensions based on the affine function specifically includes:

In a first phase, fix input and output of the following four dimensions: wind direction o, temperature t, humidity h, and air pressure p; and perform affine transformation on input of the following dimension based on the input of the four dimensions to obtain output of the following dimension: wind speed s. A formula for the affine transformation is sᵢ₊₁=wₛ (oᵢ,tᵢ,hᵢ,pᵢ)*sᵢ+wₑ(oᵢ,tᵢ,hᵢ,pᵢ). A scaling function wₛ and a translation function wₑ are neural network models to be learned.

In a second phase, fix input and output of the following four dimensions: wind speed s, temperature t, humidity h, and air pressure p; and perform affine transformation on input of the following dimension based on the input of the four dimensions to obtain output of the following dimension: wind direction o.

In a third phase, fix input and output of the following four dimensions: wind speed s, wind direction o, humidity h, and air pressure p; and perform affine transformation on input of the following dimension to obtain output of the following dimension: temperature t.

In a fourth phase, fix input and output of the following four dimensions: wind speed s, wind direction o, temperature t, and air pressure p; and perform affine transformation on input of the following dimension to obtain output of the following dimension: humidity h.

In a fifth phase, fix input and output of the following four dimensions: wind speed s, wind direction o, temperature t, and humidity h; and perform affine transformation on input of the following dimension to obtain output of the following dimension: air pressure p.

Mutual conversion of fusion and splitting is achievable because the affine transformation is an invertible process. The interactions among the meteorological data dimensions are discernible through alternate transformation applied across the five phases. Learning the interactions improve accuracy of generating the future wind farm meteorological data in both forward and backward fusion and splitting conversion processes. The affine coupling layer explores the interactions among the different dimensions of meteorological data, and maintains the interactions in the backward process to prevent interactions among different dimensions of meteorological data obtained by combining the future wind farm meteorological data and the future meteorological forecast data from deviating from interactions among different dimensions of meteorological data obtained by combining the historical wind farm meteorological data and the historical meteorological forecast data in the forward process.

A specific implementation method is as follows:

The system mainly includes three modules: a wind lidar fault detection module (namely, the detection module), a data fusion and splitting module, and a wind lidar data transmission channel switching module (namely, the data switching module).

The wind lidar fault detection module assesses variability of data output by the wind lidar over time, and if there is no change in various data (such as the air pressure, wind speed, wind direction, and temperature) within 10 minutes, may determine that the wind lidar is faulty and output the logical value of 0; otherwise, output the logical value of 1.

The data switching module changes the data source of the system for temporarily replacing functionality of a faulty wind lidar based on an output result of the logical value, specifically, switches the data source of the system for temporarily replacing functionality of a faulty wind lidar from the simulation system data source to the wind lidar data source when the logical value changes from 0 to 1, switches the data source of the system for temporarily replacing functionality of a faulty wind lidar from the wind lidar data source to the simulation system data source when the logical value changes from 1 to 0, and maintains the original status when the logical value does not change.

The data fusion and splitting module needs to fuse and split the high-resolution historical wind farm meteorological data and the low-resolution historical meteorological forecast data into the latent noise variable; and restore the latent noise variable to the following five types of high-resolution future wind farm meteorological data through the low-resolution future meteorological forecast data: wind speed, wind direction, temperature, air pressure, and humidity. The five types of meteorological data have a close correlation, but dependencies (namely, the interactions) among them is difficult to describe through an explicit mathematical formula. In addition, although a multidimensional space composed of historical data sequences of the five types of meteorological data contains huge priori knowledge, a complex multidimensional distribution cannot be described through an empirical distribution expression.

At present, a highest resolution scale of meteorological sources for weather forecasts is 25 kilometers, providing coarse content. However, a typical layout range for wind turbines in a wind farm is 3 kilometers to 5 kilometers, requiring very fine meteorological change information. To reconstruct the high-resolution future wind farm meteorological data from low-resolution historical weather forecast data (namely, the low-resolution historical meteorological forecast data) and the high-resolution historical wind farm meteorological data, the high-resolution historical wind farm meteorological data and the low-resolution historical meteorological forecast data may be fused into hybrid distribution data and split into the latent noise variable, and then the latent noise variable is inversely restored to the ideal high-resolution future wind farm meteorological data under the action of the low-resolution future meteorological forecast data. The meteorological data includes information in five dimensions: wind speed, wind direction, temperature, air pressure, and humidity. Therefore, in the embodiments of the present application, a functional mapping relationship between the low-resolution meteorological forecast data and the high-resolution wind farm meteorological data is not directly learned, but the conditional autoregressive flow model is used to fuse the high-resolution historical wind farm meteorological data and the low-resolution historical meteorological forecast data and explore the interactions among the different dimensions of historical meteorological data in the forward process; and restore the latent noise variable obtained through splitting in the forward process to the high-resolution future wind farm meteorological data under the action of the low-resolution future meteorological forecast data through the invertible structure and maintain the interactions among the different dimensions of historical meteorological data in the backward process.

Assuming that noise distributions of training data and test data are the same, an overall framework of the conditional autoregressive flow model designed in the embodiments of the present application is as follows: In a training phase, it is an encoding process. Guided by low-resolution historical meteorological forecast data sequences, the high-resolution historical wind farm meteorological data is encoded through an invertible neural network into the latent noise variable obeying a specific distribution. In an inference phase, it transforms into a decoding process. The original latent noise variable is decoded into the high-resolution future wind farm meteorological data under the action of the low-resolution future meteorological forecast data. A parameter of the conditional autoregressive flow model is updated through a maximum likelihood function and a gradient descent method. The conditional autoregressive flow model can effectively resolve a learning problem and a fusion and splitting problem of multidimensional data.

The conditional autoregressive flow model is composed of the compression layer, periodic fitting layer, invertible convolutional layer, affine coupling layer, and splitting layer. The compression layer compresses the high-resolution historical meteorological information (namely, the high-resolution historical wind farm meteorological data) and the low-resolution historical meteorological information (namely, the low-resolution historical meteorological forecast data), extracts their key features, and inputs the key features into the periodic fitting layer in the forward process; and restores the combination of the future meteorological forecast data and the latent noise variable to the future wind farm meteorological data in the backward process. On the contrary, the splitting layer converts one piece of data obtained through the splitting into the latent noise variable and ensures that another piece of data obtained through the splitting has maximum similarity with the historical meteorological forecast data in the forward process; and receives the future meteorological forecast data, and combines the future meteorological forecast data with the latent noise variable into the hybrid multi-resolution data in the backward process. The periodic fitting layer learns the periodic patterns of the data obtained by compressing the historical wind farm meteorological data and the historical meteorological forecast data through the compression layer in the forward process; and ensures that the generated future wind farm meteorological data adheres to the learned periodic patterns in the backward process. The invertible convolutional layer shuffles and reorganizes the different dimensions of information (namely, the wind speed, wind direction, temperature, air pressure, and humidity in the historical wind farm meteorological data and the historical meteorological forecast data), and inputs the shuffled and reorganized information into the affine coupling layer. The affine coupling layer obtains the interaction between each dimension in the wind speed, wind direction, temperature, air pressure, and humidity and the other dimensions based on the affine function. The affine coupling layer is configured to learn and maintain the interactions among the different dimensions of meteorological data. In view of the internal interactions among the five dimensions, namely, wind speed, wind direction, temperature, air pressure, and humidity, to explore the interaction between any dimension and the other dimensions, an interaction mechanism of different dimensions based on affine transformation is designed in the embodiments of the present application.

In a first phase, fix input oᵢ,tᵢ,hᵢ,pᵢ and output oᵢ₊₁,tᵢ₊₁,hᵢ₊₁,pᵢ₊₁ of the following four dimensions: wind direction o, temperature t, humidity h, and air pressure p, that is, oᵢ₊₁,tᵢ₊₁,hᵢ₊₁,pᵢ₊₁=oᵢ,tᵢ,hᵢ,pᵢ; and perform affine transformation on input sᵢ based on the input oᵢ,tᵢ,hᵢ,pᵢ of the four dimensions to obtain output sᵢ₊₁, where s denotes the wind speed dimension. A formula for the affine transformation is sᵢ₊₁=wₛ(oᵢ,tᵢ,hᵢ,pᵢ)*sᵢ+wₑ(oᵢ,tᵢ,hᵢ,pᵢ). A scaling function wₛ and a translation function wₑ are neural network models to be learned.

In a second phase, fix input sᵢ,tᵢ,hᵢ,pᵢ and output sᵢ₊₁,tᵢ₊₁,hᵢ₊₁,pᵢ₊₁ of the following four dimensions: wind speed s, temperature t, humidity h, and air pressure p; and perform affine transformation on input oᵢ based on the input sᵢ,tᵢ,hᵢ,pᵢ of the four dimensions to obtain output oᵢ₊₁, where o denotes the wind direction dimension. A formula for the affine transformation is oᵢ₊₁=wₛ(sᵢ,tᵢ,hᵢ,pᵢ)*oᵢ+wₑ(sᵢ,tᵢ,hᵢ,pᵢ).

In a third phase, fix input sᵢ, oᵢ,hᵢ,pᵢ and output sᵢ₊₁,oᵢ₊₁,hᵢ₊₁,oᵢ₊₁ of the following four dimensions: wind speed s, wind direction o, humidity h, and air pressure p; and perform affine transformation on input tᵢ based on the input sᵢ,oᵢ,hᵢ,pᵢ of the four dimensions to obtain output tᵢ₊₁, where t denotes the temperature dimension. A formula for the affine transformation is tᵢ₊₁=wₛ(sᵢ,oᵢ,hᵢ,pᵢ)*tᵢ+wₑ(sᵢ,oᵢ,hᵢ,pᵢ).

In a fourth phase, fix input sᵢ, oᵢ,tᵢ,pᵢ and output sᵢ₊₁,oᵢ₊₁,tᵢ₊₁,pᵢ₊₁ of the following four dimensions: wind speed s, wind direction o, temperature t, and air pressure p; and perform affine transformation on input hᵢ based on the input sᵢ,oᵢ,tᵢ,pᵢ of the four dimensions to obtain output hᵢ₊₁, where h denotes the humidity dimension. A formula for the affine transformation is hᵢ₊₁=wₛ(sᵢ,oᵢ,tᵢ,pᵢ)*hᵢ+wₑ(sᵢ,oᵢ,tᵢ,pᵢ).

In a fifth phase, fix input sᵢ,oᵢ,tᵢ,hᵢ and output sᵢ₊₁,oᵢ₊₁,tᵢ₊₁,hᵢ₊₁ of the following four dimensions: wind speed s, wind direction o, temperature t, and humidity h; and perform affine transformation on input pᵢ based on the input sᵢ,oᵢ,tᵢ,hᵢ of the four dimensions to obtain output pᵢ₊₁, where p denotes the air pressure dimension. A formula for the affine transformation is pᵢ₊₁=wₛ(sᵢ,oᵢ,tᵢ,hᵢ)*pᵢ+wₑ(sᵢ,oᵢ,tᵢ,hᵢ).

Mutual conversion of fusion and splitting is achievable because the affine transformation is an invertible process. The interactions among the meteorological data dimensions are discernible through alternate transformation applied across the five phases. Learning the interactions improves accuracy of generating the future wind farm meteorological data in both forward and backward fusion and splitting conversion processes.

Generally, it may be considered that a change in a meteorological status obeys a Markov characteristic. Specifically, a meteorological status x_{T+1} at a next moment is determined only by a meteorological status x_{T} at a current moment. In combination with the Markov characteristic, the meteorological status x_{T} at each moment should be closely related to a meteorological status x_{T-1} at a previous moment and the meteorological status x_{T+1} at the next moment, and unrelated to a status at a non-adjacent moment. Wind farm meteorological data yr at the current moment may be regarded as a conditional probability P(y_{T}|x_{T-1}, x_{T}, x_{T+1}) formed by meteorological forecast data at adjacent moments. In view of this, a bidirectional flow structure of a time-lagged flow and a time-advanced flow is introduced in the present application to guide reconstruction of high-resolution wind farm meteorological data. An output feature of the time-lagged flow is λ_{zT}=F_{Z}(x_{T}, x_{T-1}, λ_{T-1}). The feature propagates information in a lagged direction. An output feature of the time-advanced flow is modeled as λ_{cT}=F_{c}(x_{T}, x_{T+1}, λ_{T+1}). The feature propagates information in an advanced direction. F_{Z} and F_{c} represent learnable neural network modules. The neural network module is a neural network including a normalization layer, an activation layer, and a linear layer. λ is a feature transformed by the neural network module, which is an output result of the module and is returned to the neural network module as input. Act represents a feature transformed by the neural network module F_{c}, λ_{zT} represents a feature transformed by the neural network module F_{Z}, λ_{T-1}=F_{Z}(x_{T-1}, x_{T-2}, λ_{T-2}) is a lagged feature obtained at a moment (T−1), and λ_{T+1}=F_{c}(x_{T+1}, x_{T+2}, λ_{T+2}) is an advanced feature obtained at a moment (T+1), forming a flow cycle. λ_{cT} and λ_{zT} are used as output feature values of the time-advanced flow and the time-lagged flow in two opposite directions, which are fused and spliced into a variation feature of low-resolution meteorological forecast data at the current moment and adjacent moments. This serves as a condition for updating high-resolution wind farm meteorological data at a target moment. Network weights of F_{Z} and F_{c} at each time point are mutually shared. Weights of the conditional autoregressive flow model are not shared, but are interrelated. In this way, information of each output high-resolution wind farm meteorological data can fully interact with low-resolution neighborhood meteorological forecast data.

Considering a diurnal variation characteristic of weather over time, generally, from the early morning of the first day to the early morning of the second day, the temperature t gradually rises from low to high and then gradually falls from high to low, which is a periodic process. From the early morning of the first day to the early morning of the second day, the humidity h gradually falls from high to low and then gradually rises from low to high, which is a periodic process. Therefore, the two dimensions of data should exhibit cyclic, periodic trends. However, these trends are mainly affected by sunrise and sunset. The time of sunrise and sunset is dynamically changed. Sunrise is early and sunset is late in summer, and sunrise is late and sunset is early in winter, which is not a fixed time period. In view of this, a variable periodic fitting layer is introduced in the embodiments of the present application to perform trigonometric function transformation on a time T (representing a specific hour in a day). Based on division of a year into 12 months, 12 different time periods are constructed. In the forward process, the periodic fitting layer approximates periodic patterns of the temperature and humidity in the year through a hybrid combination

$$( \hat{{t}_{T}} , \hat{{h}_{T}} ) = {\sum }_{j = 1}^{12} [ {a}_{j} sin ( \frac{2 π jT}{24} ) + {b}_{j} cos ( \frac{2 π jT}{24} ) ] + ( {t}_{T} , {h}_{T} )$$

Of 12 sine functions and cosine functions. j represents a time period. For example, when j is equal to 1, it represents the first time period. When j is equal to 2, it represents the second time period. By analogy, when j is equal to 12, it represents the 12^{th} time period. a and b are learnable weighting coefficients of the variable periodic fitting layer, which determine a “weight” or an “amplitude” of each sine component and cosine component in a final superposition result. (t_{T}, h_{T}) represents temperature and humidity dimensions output by another network layer. Specifically, (t_{T}, h_{T}) represents temperature and humidity dimensions output by the compression layer in the forward process, and temperature and humidity dimensions output by the invertible convolutional layer in the backward process. An expression in the backward process is

$$( \hat{{t}_{T}} , \hat{{h}_{T}} ) = ( {t}_{T} , {h}_{T} ) - {\sum }_{j = 1}^{12} [ {a}_{j} sin ( \frac{2 π jT}{24} ) + {b}_{j} cos ( \frac{2 π jT}{24} ) ] .$$

$$( \hat{{t}_{T}} , \hat{{h}_{T}} )$$

represents temperature and humidity dimensions after periodic prior modulation. In this way, the conditional autoregressive flow model fully learns periodic patterns of sequence dynamics, to guide accurate construction of wind farm meteorological data.

In a normal period without radar faults, a backward isolation apparatus is used to transmit the output data of the wind lidar to the simulation system. One piece of data obtained through the splitting by the splitting layer maintains maximum similarity with the historical meteorological forecast data. Bidirectional flow data generated from the historical meteorological forecast data is forward-superimposed with the historical wind farm meteorological data. When the radar is faulty, the future meteorological forecast data is directly input into the splitting layer, and bidirectional flow data generated from the future meteorological forecast data is inverted and added with the latent noise variable input into the compression layer and inverse-transformed data from the future meteorological forecast data.

In the embodiments of the present application, a joint probability distribution that learns the high-resolution historical wind farm meteorological data and the low-resolution historical meteorological forecast data is proposed, which is first mapped to a latent noise variable distribution in the forward process, and then mapped to a probability distribution of high-resolution wind lidar meteorological data (namely, the wind farm meteorological data) in the backward process. The mapping relationship is modeled through the invertible conditional autoregressive flow model. Conditional autoregressive flows adopt a multidimensional, multiphase alternate transformation approach, with flow information propagated in two different directions: the lagged and advanced directions. In this way, continuity and divergence of different time features can be fully explored. In addition, the periodic patterns of weather with sunrise and sunset can be learned through triangular function transformation (namely, the periodic fitting layer).

It can be learned from the description of the foregoing embodiment that in the embodiments of the present application, when it is detected that the wind lidar is faulty, the data source of the system for temporarily replacing functionality of a faulty wind lidar is switched from the wind lidar data source to the simulation system data source. The high-resolution wind farm meteorological data and the low-resolution historical meteorological forecast data are fused and split, and the high-resolution future wind farm meteorological data is obtained through restoration under the action of the low-resolution future meteorological forecast data. In this way, missing meteorological information can be generated during a fault period of the wind lidar, and negative impact of the wind lidar fault on assessment of wind farm output can be reduced.

### System Embodiment

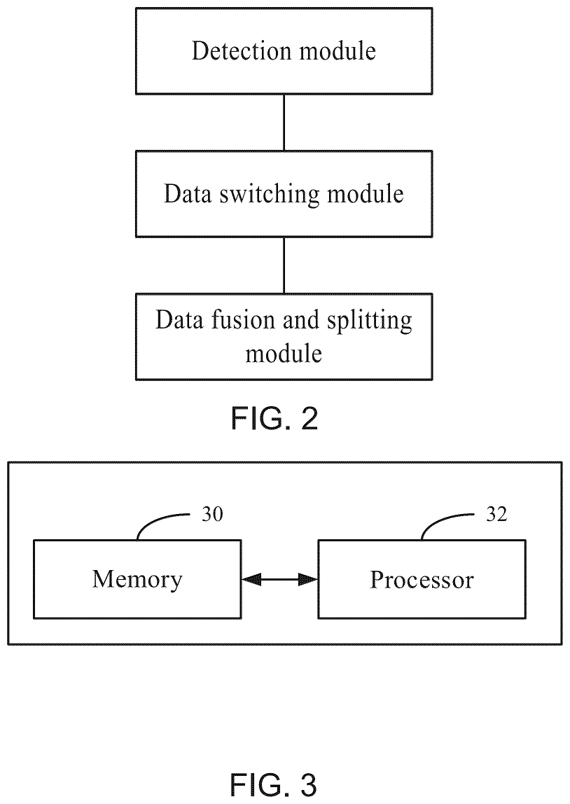

The embodiments of the present application provide a system for temporarily replacing functionality of a faulty wind lidar. FIG. 2 is a schematic diagram of a system for temporarily replacing functionality of a faulty wind lidar according to an embodiment of the present application. As shown in FIG. 2, the system specifically includes:
a detection module configured to analyze output data of a wind lidar, determine, based on an analysis result, whether the wind lidar is faulty, and in response to that the wind lidar is faulty, output a logical value of 0; or in response to that the wind lidar is not faulty, output a logical value of 1;
a data switching module configured to switch a data source of the system for temporarily replacing functionality of a faulty wind lidar from a simulation system data source to a wind lidar data source when the logical value changes from 0 to 1, switch the data source of the system for temporarily replacing functionality of a faulty wind lidar from the wind lidar data source to the simulation system data source when the logical value changes from 1 to 0, and maintain an original status when the logical value does not change; and
a data fusion and splitting module that first fuses and splits high-resolution historical wind farm meteorological data and low-resolution historical meteorological forecast data into a latent noise variable, and then restores the latent noise variable to high-resolution future wind farm meteorological data under action of low-resolution future meteorological forecast data. High resolution means that data is obtained on a small scale with high accuracy. Low resolution means that data is obtained on a large scale with low accuracy.

The data fusion and splitting module is specifically configured to use a conditional autoregressive flow model to fuse the high-resolution historical wind farm meteorological data and the low-resolution historical meteorological forecast data and explore interactions among different dimensions of historical meteorological data in a forward process; and restore the latent noise variable obtained through splitting in the forward process to the high-resolution future wind farm meteorological data under the action of the low-resolution future meteorological forecast data through an invertible structure and maintain the interactions among the different dimensions of historical meteorological data in a backward process.

The conditional autoregressive flow model includes a compression layer, a periodic fitting layer, an invertible convolutional layer, an affine coupling layer, and a splitting layer that are sequentially connected. The compression layer compresses high-resolution historical meteorological information (namely, the high-resolution historical wind farm meteorological data) and low-resolution historical meteorological information (namely, the low-resolution historical meteorological forecast data), extracts their key features, and inputs the key features into the periodic fitting layer in the forward process; and is configured to restore a combination of the future meteorological forecast data and the latent noise variable to the future wind farm meteorological data in the backward process. The periodic fitting layer is configured to ensure that the generated future wind farm meteorological data adheres to the learned periodic patterns, specifically, in the forward process, learn the periodic patterns of data obtained by compressing the historical wind farm meteorological data and the historical meteorological forecast data through the compression layer; and in the backward process, ensure that the generated future wind farm meteorological data adheres to the learned periodic patterns. The invertible convolutional layer shuffles and reorganizes different dimensions of information (namely, a wind speed, wind direction, temperature, air pressure, and humidity in the historical wind farm meteorological data and the historical meteorological forecast data), and inputs shuffled and reorganized information into the affine coupling layer. In the affine coupling layer, affine functions are employed to characterize the interactions of each meteorological dimension (wind speed, wind direction, temperature, pressure, and humidity) with the other dimensions. The affine coupling layer is configured to learn and maintain the interactions among the different dimensions of meteorological data. The splitting layer converts one piece of data obtained through splitting into the latent noise variable and ensure that another piece of data obtained through the splitting has maximum similarity with the historical meteorological forecast data; and in the backward process, receives the future meteorological forecast data, and combines the future meteorological forecast data with the latent noise variable into hybrid multi-resolution data. A condition of the conditional autoregressive flow model is to achieve maximal fluidity by performing both forward and backward information propagation based on neighborhood content of the low-resolution meteorological forecast data, which effectively guides construction of the high-resolution future wind farm meteorological data.

That the affine coupling layer obtains the interaction between each dimension in the wind speed, wind direction, temperature, air pressure, and humidity and the other dimensions based on the affine function specifically includes: In a first phase, fix input oᵢ,tᵢ,hᵢ,pᵢ and output oᵢ₊₁,tᵢ₊₁,hᵢ₊₁,pᵢ₊₁ of the following four dimensions: wind direction o, temperature t, humidity h, and air pressure p, that is, oᵢ₊₁,tᵢ₊₁,hᵢ₊₁,pᵢ₊₁=oᵢ,tᵢ,hᵢ,pᵢ; and perform affine transformation on input sᵢ based on the input oᵢ,tᵢ,hᵢ,pᵢ of the four dimensions to obtain output sᵢ₊₁, where s denotes the wind speed dimension. A formula for the affine transformation is sᵢ₊₁=wₛ(oᵢ,tᵢ,hᵢ,pᵢ)*sᵢ+wₑ(oᵢ,tᵢ,hᵢ,pᵢ). A scaling function wₛ and a translation function wₑ are neural network models to be learned. In a second phase, fix input sᵢ,tᵢ,hᵢ,pᵢ and output sᵢ₊₁,tᵢ₊₁,hᵢ₊₁,pᵢ₊₁ of the following four dimensions: wind speed s, temperature t, humidity h, and air pressure p; and perform affine transformation on input oᵢ based on the input sᵢ,tᵢ,hᵢ,pᵢ of the four dimensions to obtain output oᵢ₊₁, where o denotes the wind direction dimension. In a third phase, fix input sᵢ,oᵢ,hᵢ,pᵢ and output sᵢ₊₁,oᵢ₊₁,hᵢ₊₁,pᵢ₊₁ of the following four dimensions: wind speed s, wind direction o, humidity h, and air pressure p; and perform affine transformation on input tᵢ based on the input sᵢ,oᵢ,hᵢ,pᵢ of the four dimensions to obtain output tᵢ₊₁, where t denotes the temperature dimension. In a fourth phase, fix input sᵢ,oᵢ,tᵢ,pᵢ and output sᵢ₊₁,oᵢ₊₁,tᵢ₊₁,pᵢ₊₁ of the following four dimensions: wind speed s, wind direction o, temperature t, and air pressure p; and perform affine transformation on input hᵢ based on the input sᵢ,oᵢ,tᵢ,pᵢ of the four dimensions to obtain output hᵢ₊₁, where h denotes the humidity dimension. In a fifth phase, fix input sᵢ,oᵢ,tᵢ,hᵢ and output sᵢ₊₁,oᵢ₊₁,tᵢ₊₁,hᵢ₊₁ of the following four dimensions: wind speed s, wind direction o, temperature t, and humidity h; and perform affine transformation on input pᵢ based on the input sᵢ, oᵢ,tᵢ,hᵢ of the four dimensions to obtain output pᵢ₊₁, where p denotes the air pressure dimension. Mutual conversion of fusion and splitting is achievable because the affine transformation is an invertible process. The interactions among the meteorological data dimensions are discernible through alternate transformation applied across the five phases. Learning the interactions improves accuracy of generating the future wind farm meteorological data in both forward and backward fusion and splitting conversion processes.

In this embodiment of the present application, the detection module, the data fusion and splitting module, and the data switching module each may be one or more processors, controllers, or chips that each have a communication interface and can implement a communication protocol, and may further include a memory, a related interface, a system transmission bus, and the like if necessary. The processor, controller, or chip executes program-related code to implement a corresponding function. In an alternative solution, the detection module, the data fusion and splitting module, and the data switching module share an integrated chip or share devices such as a processor, a controller, and a memory. The shared processor, controller, or chip executes program-related code to implement a corresponding function.

This embodiment of the present application is a system embodiment corresponding to the foregoing method embodiment. A specific operation of each module can be understood by referring to the description of the method embodiment. Details are not described herein again.

### Apparatus Embodiment 1

An embodiment of the present application provides an apparatus for temporarily replacing functionality of a faulty wind lidar, as shown in FIG. 3, including a memory 30, a processor 32, and a computer program stored in the memory 30 and executable on the processor 32. The computer program, when executed by the processor, implements the steps in the foregoing method embodiment.

### Apparatus Embodiment 2

An embodiment of the present application provides a non-transitory computer-readable storage medium. The non-transitory computer-readable storage medium stores a program for implementing information transfer. The program, when executed by the processor 32, implements the steps in the foregoing method embodiment.

### Apparatus Embodiment 3

An embodiment of the present application provides a computer program product, including a non-transitory computer-readable storage medium that contains computer-readable program code. The computer-readable program code, when executed by the processor 32, implements the steps in the foregoing method embodiment.

Finally, it should be noted that the foregoing embodiments are merely used to explain the technical solutions of the present application, but are not intended to limit the present application. Although the present application is described in detail with reference to the foregoing embodiments, persons of ordinary skill in the art should understand that they can still modify the technical solutions described in the foregoing embodiments, or make equivalent substitutions on some or all technical features therein. These modifications or substitutions do not make the essence of the corresponding technical solutions deviate from the scope of the technical solutions of the embodiments of the present application.

1. A system for temporarily replacing functionality of a faulty wind lidar, comprising:
a detection module configured to analyze output data of a wind lidar, determine, based on an analysis result, whether the wind lidar is faulty, and in response to that the wind lidar is faulty, output a logical value of 0; or in response to that the wind lidar is not faulty, output a logical value of 1;
a data switching module configured to switch a data source of the system for temporarily replacing functionality of a faulty wind lidar from a simulation system data source to a wind lidar data source in response to that the logical value changes from 0 to 1, switch the data source of the system for temporarily replacing functionality of a faulty wind lidar from the wind lidar data source to the simulation system data source in response to that the logical value changes from 1 to 0, and maintain an original status in response to the logical value does not change; and
a data fusion and splitting module configured to fuse and split historical wind farm meteorological data and historical meteorological forecast data into a latent noise variable, and restore the latent noise variable to future wind farm meteorological data under action of future meteorological forecast data.

2. The system according to claim 1, wherein the data fusion and splitting module is configured to use a conditional autoregressive flow model to fuse the historical wind farm meteorological data and the historical meteorological forecast data and explore interactions among different dimensions of historical meteorological data in a forward process; and restore the latent noise variable obtained through splitting in the forward process to the future wind farm meteorological data under the action of the future meteorological forecast data through an invertible structure and maintain the interactions among the different dimensions of historical meteorological data in a backward process.

3. The system according to claim 2, wherein the conditional autoregressive flow model comprises a compression layer, a periodic fitting layer, an invertible convolutional layer, an affine coupling layer, and a splitting layer that are sequentially connected;
the compression layer is configured to: in the forward process, compress the historical wind farm meteorological data and the historical meteorological forecast data, extract key features of the historical wind farm meteorological data and the historical meteorological forecast data, and input the key features into the periodic fitting layer, wherein the key features comprise a wind speed, wind direction, temperature, air pressure, and humidity; and in the backward process, restore a combination of the future meteorological forecast data and the latent noise variable to the future wind farm meteorological data;
the periodic fitting layer is configured to: in the forward process, learn periodic patterns of data obtained by compressing the historical wind farm meteorological data and the historical meteorological forecast data through the compression layer; and in the backward process, ensure that the generated future wind farm meteorological data adheres to the learned periodic patterns;
the invertible convolutional layer is configured to shuffle and reorganize the wind speed, wind direction, temperature, air pressure, and humidity in the historical wind farm meteorological data and the historical meteorological forecast data, and input shuffled and reorganized information into the affine coupling layer;
the affine coupling layer is configured to obtain an interaction between each dimension in the wind speed, wind direction, temperature, air pressure, and humidity and the other dimensions based on an affine function, and learn and maintain the interactions among the different dimensions of meteorological data;
the splitting layer is configured to: in the forward process, convert one piece of data obtained through splitting into the latent noise variable and ensure that another piece of data obtained through the splitting has maximum similarity with the historical meteorological forecast data; and in the backward process, receive the future meteorological forecast data, and combine the future meteorological forecast data with the latent noise variable into hybrid multi-resolution data; and
a condition of the conditional autoregressive flow model is to achieve maximal fluidity by performing both forward and backward information propagation based on neighborhood content of the future meteorological forecast data, to guide construction of the future wind farm meteorological data.

4. The system according to claim 3, wherein that the affine coupling layer is configured to obtain the interaction between each dimension in the wind speed, wind direction, temperature, air pressure, and humidity and the other dimensions based on the affine function comprises:
in a first phase, fixing input oᵢ,tᵢ,hᵢ,pᵢ and output oᵢ₊₁,tᵢ₊₁,hᵢ₊₁,pᵢ₊₁ of the following four dimensions: wind direction o, temperature t, humidity h, and air pressure p, that is, oᵢ₊₁,tᵢ₊₁,hᵢ₊₁,pᵢ₊₁=oᵢ,tᵢ,hᵢ,pᵢ; and performing affine transformation on input sᵢ based on the input oᵢ,tᵢ,hᵢ,pᵢ of the four dimensions to obtain output sᵢ₊₁, wherein s denotes the wind speed dimension, a formula for the affine transformation is sᵢ₊₁=wₛ(oᵢ,tᵢ,hᵢ,pᵢ)*sᵢ+wₑ(oᵢ,tᵢ,hᵢ,pᵢ), and a scaling function wₛ and a translation function wₑ are neural network models to be learned;
in a second phase, fixing input sᵢ,tᵢ,hᵢ,pᵢ and output sᵢ₊₁,tᵢ₊₁,hᵢ₊₁,pᵢ₊₁ of the following four dimensions: wind speed s, temperature t, humidity h, and air pressure p; and performing affine transformation on input oᵢ based on the input sᵢ,tᵢ,hᵢ,pᵢ of the four dimensions to obtain output oᵢ₊₁, wherein o denotes the wind direction dimension;
in a third phase, fixing input sᵢ, oᵢ,hᵢ,pᵢ and output sᵢ₊₁,oᵢ₊₁,hᵢ₊₁,pᵢ₊₁ of the following four dimensions: wind speed s, wind direction o, humidity h, and air pressure p; and performing affine transformation on input tᵢ based on the input sᵢ,oᵢ,hᵢ,pᵢ of the four dimensions to obtain output tᵢ₊₁, wherein t denotes the temperature dimension;
in a fourth phase, fixing input sᵢ,oᵢ,tᵢ,pᵢ and output sᵢ₊₁,oᵢ₊₁,tᵢ₊₁,pᵢ₊₁ of the following four dimensions: wind speed s, wind direction o, temperature t, and air pressure p; and performing affine transformation on input hᵢ based on the input sᵢ,oᵢ,tᵢ,pᵢ of the four dimensions to obtain output hᵢ₊₁, wherein h denotes the humidity dimension; and
in a fifth phase, fixing input sᵢ, oᵢ,tᵢ,hᵢ and output sᵢ₊₁,oᵢ₊₁,tᵢ₊₁,hᵢ₊₁ of the following four dimensions: wind speed s, wind direction o, temperature t, and humidity h; and performing affine transformation on input pᵢ based on the input sᵢ,oᵢ,tᵢ,hᵢ of the four dimensions to obtain output pᵢ₊₁, wherein p denotes the air pressure dimension; wherein
mutual conversion of fusion and splitting is achievable because the affine transformation is an invertible process, the interactions among the meteorological data dimensions are discernible through alternate transformation applied across the five phases, and learning the interactions improves accuracy of generating the future wind farm meteorological data in both forward and backward fusion and splitting conversion processes.

5. A method for temporarily replacing functionality of a faulty wind lidar, comprising:
analyzing, by a detection module, output data of a wind lidar, determining, based on an analysis result, whether the wind lidar is faulty, and in response to the wind lidar is faulty, outputting a logical value of 0; or in response to the wind lidar is not faulty, outputting a logical value of 1;
switching, by a data switching module, a data source of a system for temporarily replacing functionality of a faulty wind lidar from a simulation system data source to a wind lidar data source in response to the output logical value changes from 0 to 1, switching the data source of the system for temporarily replacing functionality of a faulty wind lidar from the wind lidar data source to the simulation system data source in response to that the logical value changes from 1 to 0, and maintaining an original status in response to the logical value does not change; and
fusing and splitting, by a data fusion and splitting module, historical wind farm meteorological data and historical meteorological forecast data into a latent noise variable, and restoring the latent noise variable to future wind farm meteorological data under action of future meteorological forecast data.

6. The method according to claim 5, wherein the data fusion and splitting module uses a conditional autoregressive flow model to fuse the historical wind farm meteorological data and the historical meteorological forecast data and explore interactions among different dimensions of historical meteorological data in a forward process; and restore the latent noise variable obtained through splitting in the forward process to the future wind farm meteorological data under the action of the future meteorological forecast data through an invertible structure and maintain the interactions among the different dimensions of historical meteorological data in a backward process.

7. The method according to claim 6, wherein the conditional autoregressive flow model comprises a compression layer, a periodic fitting layer, an invertible convolutional layer, an affine coupling layer, and a splitting layer that are sequentially connected;
the compression layer is configured to: in the forward process, compress the historical wind farm meteorological data and the historical meteorological forecast data, extract key features of the historical wind farm meteorological data and the historical meteorological forecast data, and input the key features into the periodic fitting layer; and in the backward process, restore a combination of the future meteorological forecast data and the latent noise variable to the future wind farm meteorological data;
the periodic fitting layer is configured to: in the forward process, learn periodic patterns of data obtained by compressing the historical wind farm meteorological data and the historical meteorological forecast data through the compression layer; and in the backward process, ensure that generated future wind farm meteorological data adheres to the learned periodic patterns;
the invertible convolutional layer is configured to shuffle and reorganize a wind speed, wind direction, temperature, air pressure, and humidity in the historical wind farm meteorological data and the historical meteorological forecast data, and input shuffled and reorganized information into the affine coupling layer;
the affine coupling layer is configured to obtain an interaction between each dimension in the wind speed, wind direction, temperature, air pressure, and humidity and the other dimensions based on an affine function, and learn and maintain the interactions among the different dimensions of meteorological data;
the splitting layer is configured to: in the forward process, convert one piece of data obtained through splitting into the latent noise variable and ensure that another piece of data obtained through the splitting has maximum similarity with the historical meteorological forecast data; and in the backward process, receive the future meteorological forecast data, and combine the future meteorological forecast data with the latent noise variable into hybrid multi-resolution data; and
a condition of the conditional autoregressive flow model is to achieve maximal fluidity by performing both forward and backward information propagation based on neighborhood content of the future meteorological forecast data, to effectively guide construction of the future wind farm meteorological data.

8. The method according to claim 7, wherein that the affine coupling layer is configured to obtain the interaction between each dimension in the wind speed, wind direction, temperature, air pressure, and humidity and the other dimensions based on the affine function comprises:
in a first phase, fixing input oᵢ,tᵢ,hᵢ,pᵢ and output oᵢ₊₁,tᵢ₊₁,hᵢ₊₁,pᵢ₊₁ of the following four dimensions: wind direction o, temperature t, humidity h, and air pressure p, that is, oᵢ₊₁,tᵢ₊₁,hᵢ₊₁,pᵢ₊₁=oᵢ,tᵢ,hᵢ,pᵢ and performing affine transformation on input sᵢ based on the input oᵢ,tᵢ,hᵢ,pᵢ of the four dimensions to obtain output sᵢ₊₁, wherein s denotes the wind speed dimension, a formula for the affine transformation is sᵢ₊₁=wₛ(oᵢ,tᵢ,hᵢ,pᵢ)*sᵢ+wₑ(oᵢ,tᵢ,hᵢ,pᵢ), and a scaling function wₛ and a translation function wₑ are neural network models to be learned;
in a second phase, fixing input sᵢ,tᵢ,hᵢ,pᵢ and output sᵢ₊₁,tᵢ₊₁,hᵢ₊₁,pᵢ₊₁ of the following four dimensions: wind speed s, temperature t, humidity h, and air pressure p; and performing affine transformation on input oᵢ based on the input sᵢ,tᵢ,hᵢ,pᵢ of the four dimensions to obtain output oᵢ₊₁, wherein o denotes the wind direction dimension;
in a third phase, fixing input sᵢ,oᵢ,hᵢ,pᵢ and output sᵢ₊₁,oᵢ₊₁,hᵢ₊₁,pᵢ₊₁ of the following four dimensions: wind speed s, wind direction o, humidity h, and air pressure p; and performing affine transformation on input tᵢ based on the input sᵢ,oᵢ,hᵢ,pᵢ of the four dimensions to obtain output tᵢ₊₁, wherein t denotes the temperature dimension;
in a fourth phase, fixing input sᵢ,oᵢ,tᵢ,pᵢ and output sᵢ₊₁,oᵢ₊₁,tᵢ₊₁,pᵢ₊₁ of the following four dimensions: wind speed s, wind direction o, temperature t, and air pressure p; and performing affine transformation on input hᵢ based on the input sᵢ,oᵢ,tᵢ,pᵢ of the four dimensions to obtain output hᵢ₊₁, wherein h denotes the humidity dimension; and
in a fifth phase, fixing input sᵢ,oᵢ,tᵢ,hᵢ and output sᵢ₊₁,oᵢ₊₁,tᵢ₊₁,hᵢ₊₁ of the following four dimensions: wind speed s, wind direction o, temperature t, and humidity h; and performing affine transformation on input pᵢ based on the input sᵢ,oᵢ,tᵢ,hᵢ of the four dimensions to obtain output pᵢ₊₁, wherein p denotes the air pressure dimension; wherein
mutual conversion of fusion and splitting is achievable because the affine transformation is an invertible process, the interactions among the meteorological data dimensions are discernible through alternate transformation applied across the five phases, and learning the interactions improves accuracy of generating the future wind farm meteorological data in both forward and backward fusion and splitting conversion processes.

9. An apparatus for temporarily replacing functionality of a faulty wind lidar, comprising: a memory, a processor, and a computer program stored in the memory and executable on the processor, wherein the computer program, when executed by the processor, implements the steps of the method for temporarily replacing functionality of a faulty wind lidar according to claim 5.

10. An apparatus for temporarily replacing functionality of a faulty wind lidar, comprising: a memory, a processor, and a computer program stored in the memory and executable on the processor, wherein the computer program, when executed by the processor, implements the steps of the method for temporarily replacing functionality of a faulty wind lidar according to claim 6.

11. An apparatus for temporarily replacing functionality of a faulty wind lidar, comprising: a memory, a processor, and a computer program stored in the memory and executable on the processor, wherein the computer program, when executed by the processor, implements the steps of the method for temporarily replacing functionality of a faulty wind lidar according to claim 7.

12. An apparatus for temporarily replacing functionality of a faulty wind lidar, comprising: a memory, a processor, and a computer program stored in the memory and executable on the processor, wherein the computer program, when executed by the processor, implements the steps of the method for temporarily replacing functionality of a faulty wind lidar according to claim 8.

13. A non-transitory computer-readable storage medium, wherein the non-transitory computer-readable storage medium stores a program for implementing information transfer, and the program, when executed by a processor, implements the steps of the method for temporarily replacing functionality of a faulty wind lidar according to claim 5.

14. A non-transitory computer-readable storage medium, wherein the non-transitory computer-readable storage medium stores a program for implementing information transfer, and the program, when executed by a processor, implements the steps of the method for temporarily replacing functionality of a faulty wind lidar according to claim 6.

15. A non-transitory computer-readable storage medium, wherein the non-transitory computer-readable storage medium stores a program for implementing information transfer, and the program, when executed by a processor, implements the steps of the method for temporarily replacing functionality of a faulty wind lidar according to claim 7.

16. A non-transitory computer-readable storage medium, wherein the non-transitory computer-readable storage medium stores a program for implementing information transfer, and the program, when executed by a processor, implements the steps of the method for temporarily replacing functionality of a faulty wind lidar according to claim 8.

17. A computer program product, comprising: a non-transitory computer-readable storage medium that contains s computer-readable program code, wherein the computer-readable program code, when executed by a processor, implements the steps of the method for temporarily replacing functionality of a faulty wind lidar according to claim 5.

18. A computer program product, comprising: a non-transitory computer-readable storage medium that contains computer-readable program code, wherein the computer-readable program code, when executed by a processor, implements the steps of the method for temporarily replacing functionality of a faulty wind lidar according to claim 6.

19. A computer program product, comprising: a non-transitory computer-readable storage medium that contains computer-readable program code, wherein the computer-readable program code, when executed by a processor, implements the steps of the method for temporarily replacing functionality of a faulty wind lidar according to claim 7.

20. A computer program product, comprising: a non-transitory computer-readable storage medium that contains computer-readable program code, wherein the computer-readable program code, when executed by a processor, implements the steps of the method for temporarily replacing functionality of a faulty wind lidar according to claim 8.
